(19) United States
(12) Patent Application Publication
(10) Pub. No.: US 2011/0289397 A1
(43) Pub. Date: Nov. 24, 2011

(54) Displaying Table Data in a Limited Display Area

(76) Inventors: Mauricio Eastmond, San Diego, CA (US); Jerrold H. Jones, La Mesa, CA (US); Santiago Becerra, SR., Del Mar, CA (US); David Becerra, Venice, CA (US); Jordan Rounds, San Diego, CA (US)

(21) Appl. No.: 13/111,831

(22) Filed: May 19, 2011

Related U.S. Application Data
(60) Provisional application No. 61/346,443, filed on May 19, 2010.

(51) Int. Cl. G06F 17/00

(52) U.S. Cl. 715/212

(57) ABSTRACT

Embodiments display table data in formats that are suitable for presentation in a limited display area. The columns can be presented in numeric/text format as well as chart format. User input allows conversion of a column displayed using numeric format to a chart format and back, for example, by double tapping on a touch sensitive screen. A key column is displayed with the chart column. Depending on the screen size, other columns may be displayed along with the chart column. Embodiments determine whether text data is displayed using a single line or multiple lines, based on percentage of labels of the column that fit within the width of the column. Various criteria determine width of columns displayed using collapsed width or expanded width. User input allows conversion of column display from collapsed width to expanded width or back, for example, by double tapping on the screen.

### CROSS REFERENCES TO RELATED APPLICATIONS

This application claims the benefit of U.S. Provisional Patent Application 61/346,443, entitled “Displaying Table Data in a Limited Display Area,” filed on May 19, 2010, which is incorporated by reference in its entirety.

### FIELD OF ART

The disclosure generally relates to displaying data using charts and tables on a device having a display area that is small relative to the amount of data being displayed.

### BACKGROUND

There are several ways to use charts or graphs to visually present statistical data available in reports including, for example, bar charts, pie charts, line graphs, and scatter graphs. On a mobile device such as a handheld device, handheld computer, cell phone, tablet computer, or personal digital assistant (PDA), graphs and charts have to be displayed on small display screens with display areas that are limited in size compared to the data being shown. There are several challenges in trying to show tables, graphs, or charts on such devices. Display of information on a limited display area requires reconciliation between conflicting goals of maximizing the amount of information displayed on one hand and presenting the data in an aesthetically appealing manner on the other hand. Attempts to present large amount of data in limited display area can lead to a display that may not be aesthetically appealing. Even small amount of increase in the information displayed on a screen with a limited display area can compromise the aesthetics of the display. On the other hand, displaying data in an aesthetically appealing manner may result in loss of information being displayed.

### SUMMARY

Embodiments of the invention display table data such that some columns can be represented visually as charts whereas others are represented textually. User input can be provided to convert columns displayed in textual format to chart format and vice versa. In one embodiment, user input for converting column formats corresponds to double tapping on the touch sensitive screen of a device. In one embodiment, a graphical format, for example, a bar is shown in each cell of the column converted to chart format with the length of the bar based on the value of the cell. Depending on the screen size used for display, one or more columns of the table may be displayed in text/numeric format along with chart columns.

Various embodiments allow determination of whether text data is displayed using a single line or multiple lines, for example double lines. The determination of whether a single line or multiple lines are used to display the data is based on a percentage of labels in cells of the column that contain data that fits within the width of the column. In one embodiment, columns can be displayed using either a collapsed width or an expanded width. User input can convert a column displayed in collapsed format to expanded format and vice versa. The collapsed and expanded widths of the columns are determined based on the size of the data present in the column as well as the size of the screen on which data is being displayed so as to display the data in an aesthetically pleasing manner. For example, the maximum expanded width of a column is limited by a maximum threshold value even if this requires labels to be truncated for display. If a column is displayed in expanded format, other columns may still be displayed. In one embodiment, only one column at a time is expanded on the display. In another embodiment, columns may be expanded to avoid truncation of numeric values.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of the architecture of a system for displaying data as bar graphs.

FIG. 2 illustrates how double tapping on a column displaying numeric data can convert the presentation of the column into a chart format, in accordance with an embodiment of the invention.

FIG. 3 illustrates how chart columns can be presented along with data columns of the chart based on the size of the display screen, in accordance with an embodiment of the invention.

FIG. 4 illustrates how a user can sort table data by selecting a chart column displayed in the table, in accordance with an embodiment of the invention.

FIG. 5 shows a flowchart illustrating the process used to determine the zero pint axis for a chart column displayed within a table, in accordance with an embodiment of the invention.

FIG. 6 shows a flowchart illustrating the process used to determine whether to display a column using single lines or double lines, in accordance with an embodiment of the invention.

FIG. 7 shows a flowchart illustrating the process used to determine the collapsed width of numeric columns, in accordance with an embodiment of the invention.

FIG. 8 shows a flowchart illustrating the process used to determine the expanded width of numeric columns, in accordance with an embodiment of the invention.

FIG. 9 shows a flowchart illustrating the process used to determine the collapsed width of alphanumeric columns, in accordance with an embodiment of the invention.

FIG. 10 shows a flowchart illustrating the process used to determine the expanded width of alphanumeric columns, in accordance with an embodiment of the invention.

FIG. 11 illustrates a device displaying a table with small column labels displayed as single lines, in accordance with an embodiment of the invention.

FIG. 12 illustrates a device displaying a table with large column labels displayed as single lines, in accordance with an embodiment of the invention.

FIG. 13 illustrates a device displaying a table with large column labels displayed as double lines, in accordance with an embodiment of the invention.

FIG. 14 shows a device illustrating a column displayed using the collapsed width of the column, in accordance with an embodiment of the invention.

FIG. 15 shows a device illustrating a column displayed using the expanded width of the column that reaches the maximum possible expanded width, in accordance with an embodiment of the invention.

FIG. 16 shows a device illustrating a column displayed using the expanded width that is less than the maximum possible expanded width, in accordance with an embodiment of the invention.

FIG. 17 shows a device illustrating a column that is displayed using a collapsed width that is same as its expanded width, in accordance with an embodiment of the invention.

FIG. 18 shows a device illustrating a column displayed using double lines with collapsed width, in accordance with an embodiment of the invention.

FIG. 19 shows a device illustrating a column displayed using double lines with expanded width, in accordance with an embodiment of the invention.

FIG. 20 shows a device illustrating a column displayed using double lines with expanded width that does not reach the maximum possible expanded width value, in accordance with an embodiment of the invention.

FIG. 21 illustrates a numeric column containing data that exceeds the column width, thereby requiring truncation of the date, in accordance with an embodiment of the invention.

FIG. 22 illustrates the numeric column data of FIG. 21 displayed without truncation, in accordance with an embodiment of the invention.

FIG. 23 shows a sample data set to be displayed as a report using a device with limited display area, in accordance with an embodiment of the invention.

FIG. 24 shows a device illustrating display of the report shown in FIG. 23 in a manner that shows empty space in the report, in accordance with an embodiment of the invention.

FIG. 25 shows a device illustrating display of the report shown in FIG. 23 in a manner that evenly distributes the empty space of the report displayed in FIG. 24, in accordance with an embodiment of the invention.

FIG. 26 describes alternative embodiments of the invention related to header expansion and scrolling of the table.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

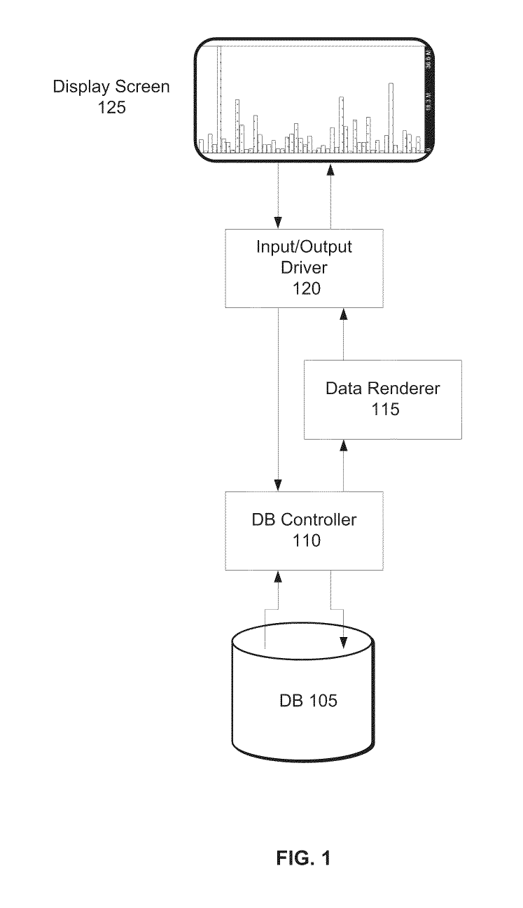

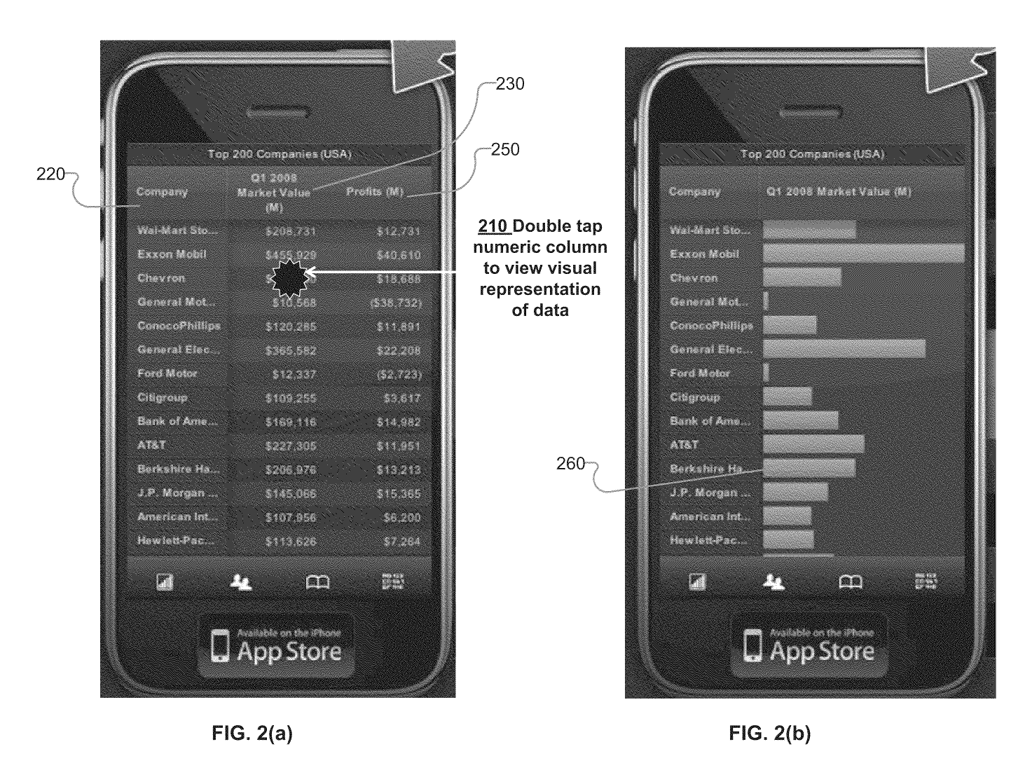

FIG. 1 is a block diagram of a system architecture in accordance with one embodiment. The components shown in FIG. 1 include a database (DB) 105, a DB controller module 110, a data renderer module 115, an input/output driver module 120, and a display screen 125. Components such as the display screen 125 are hardware components, whereas the DB controller 110 and the chart renderer 115 are software modules. As used herein, the term “module” refers to a computer program logic and/or data for providing the specified functionality. A module can be implemented in hardware, firmware, and/or software. Examples of types of computers that implement the system shown in FIG. 2 include tablet computers, smart phone devices, and mobile phones.

The DB 105 stores data and metadata associated with reports. The DB 105 in one embodiment is implemented using a hard disk drive but can also be implemented using any other device capable of storing data, such as a writeable compact disc (CD) or DVD, or a solid state memory device, for example a flash memory. In an embodiment, the DB 105 is stored on a storage device local to the device with the display screen 125. In another embodiment, a device showing the display screen 125 can interact with a remote system storing the DB 105 via a network. The DB controller module 110 implements the logic to interface with the DB 105 so as to read data from the DB 105 or write data to the DB 105. The DB controller 110 provides data to the data renderer module 115, which computes information required for rendering the data. For example, the data renderer can determine the dimensions of a chart representation of data.

The data and the information necessary for rendering the data are provided by the data renderer module 115 to the input/output driver 120. The input/output driver 120 provides the display screen 125 with instructions and data necessary for displaying data and/or images. In various embodiments, the display screen 125 is used to input data and/or commands. For example, a touch sensitive screen can sense the coordinates of the portion of the screen touched by a user. The user may touch the display screen 125, for example, to select a command from a list of commands or to select a data element from a list of data elements displayed on the screen. In some embodiments, a pointing device, such as a thumbwheel, mouse, track ball, or other type of pointing device is used to input data or commands into the system. The input/output driver 120 sends the data or instructions provided by the display screen 125 to the DB controller 110. The DB controller 110 in response to data or instructions received from the input/output driver 120 reads data from DB 105 and writes data to DB 105.

A mobile device may be used to view reports available to a user. In one embodiment, the user may be presented with a list of reports that can be reviewed. The user selects a particular report name and the data renderer module 115 computes information to render the data which is then displayed on display screen 125 in a format associated with the report. Another example scenario allows the user to associate a particular column of a report with a display mode, for example, alphanumeric representation or chart representation. The user may make a selection by touching the appropriate portion of the display screen 125 showing a column, or by providing input through another mechanism such as a keyboard or pointing device. In one embodiment, the DB controller 110 may update the metadata of the appropriate report in the DB 105 to store the information related to mode of display of the report. The information associating the report with a mode of display can be used subsequently to display the report. In one embodiment the user can interactively change formats of the columns of the report displayed. For example, a user viewing a column of the report in numeric form can provide input to convert the column to chart format and vice versa. Various other scenarios of interactions between the user and the various components and modules displayed in FIG. 1 are possible.

FIG. 2 illustrates how double tapping on a column displaying numeric data can convert the presentation of the column into a chart format, in accordance with an embodiment of the invention. FIG. 2(a) shows a device with limited display area displaying a text column 220 “Company,” a numeric column 230 “Q1 Market Value (M),” and another numeric column 250 “Profits (M).” A user can perform an action such as double tapping 210 on a portion of the touch sensitive screen of the device that displays a numeric column 230. As a result of double tapping on a column, the screen displays the data for that numeric column in a chart format 260 as shown in FIG. 2(b). Each cell corresponding to a particular numeric value in FIG. 2(a) is shown using a visual representation, for example, a chart as shown in FIG. 2(b). The chart representation may comprise shapes, for example, rectangle shapes for a bar graph. Each shape is associated with a cell of the chart column and is presented such that a property of the shape is determined based on a value associated with the cell. For example, the size of a rectangle of a bar graph depends on the value associated with the corresponding cell. In other embodiments, other properties of the shapes can depend on the value associated with the cell, for example, the color of the shape, the brightness of the shape, the type of the shape, a shading associated with the shape, and the like.

Double tapping on the chart column in FIG. 2(b) can cause the display to return to the numeric format shown in FIG. 2(a). In alternative embodiments, the user input that causes the conversion between the chart display and numeric display of a column can be single tap operation, a single/double click using a mouse, or a press of a button followed by selection of an item by the user from a displayed list. Furthermore, the user action can be either performed on the data portion of the column or the title portion of the column.

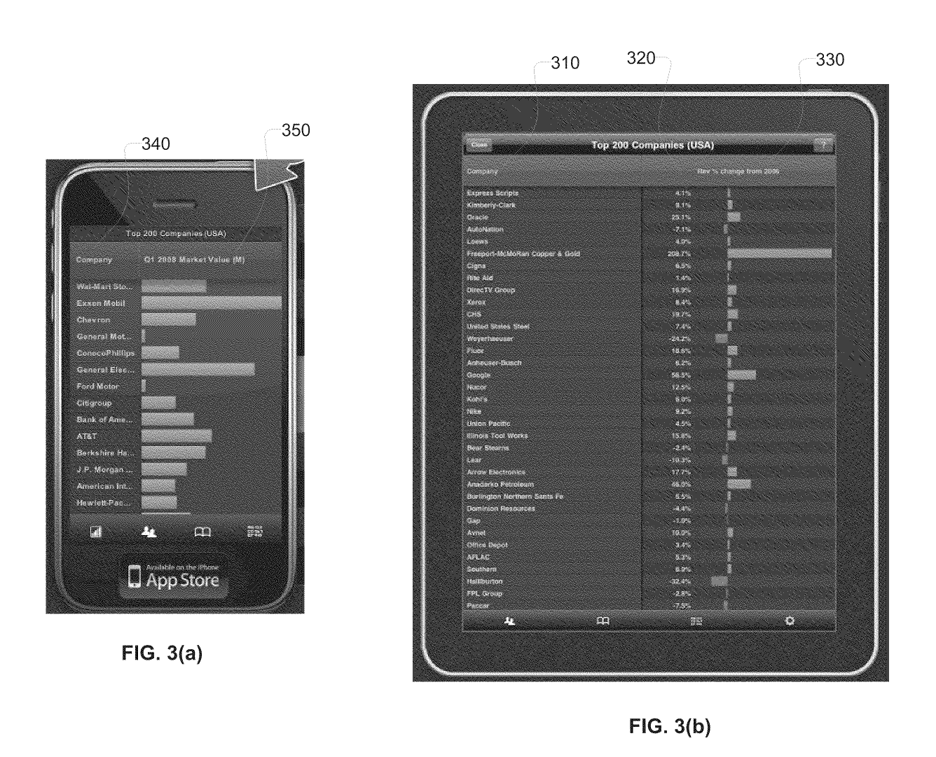

The number of columns that are displayed for a table may depend on the size of the screen of the device that is displaying the table. FIG. 3 illustrates how chart columns can be presented along with data columns of the chart based on the size of the display screen, in accordance with an embodiment of the invention. In a device with limited display area the number of columns that can be displayed depends on the display area available. For example, as shown in FIG. 3(a), small devices including mobile phones (e.g., an iPhone commercially available from Apple Inc., Cupertino, Calif.), may display a single column 340 identifying the row (e.g., “Company” column in FIG. 2(a)) along with the chart column 350. On the other hand, as shown in FIG. 3(b), devices with larger display areas may present a column 310 identifying the row, a chart column 330 displaying the chart, and a column 320 displaying the values shown in the chart column 330. In other embodiments, other columns, for example column 250 from FIG. 2(a) may also be displayed along with the chart column 330. In some embodiments, a display may show one or more columns using chart data and one or more columns using numeric data. For example a table may show 5 columns c1, c2, c3, c4, and c5 such that c1 is text data and c2-c5 are numeric values. After a user double taps on column c2, the column c2 is displayed using chart format and columns c3-c5 are displayed using numeric format. Subsequently, if the user chooses to double tap on the column c5, columns c2 and c5 are displayed using chart format and column c3 and c4 are displayed using numeric format. Subsequently the user can double tap on column c2 again, resulting in the column c5 being shown using chart format and columns c2-c4 using numeric format.

In some embodiments, if multiple columns can be displayed using chart formats, the display characteristics of each column may either be pre-configured as metadata of the table being displayed or dynamically determined based on criteria including aesthetics of the display. For example, different chart columns may be displayed using different colors. In one embodiment, even if the device displays a single column (similar to FIG. 3(a)), the characteristics of the column being displayed using chart format may be preconfigured or determined dynamically. For example, columns representing specific types of values, for example currency may be represented using a particular type of formatting whereas a value representing a number of people, for example, population, may be represented using a different type of formatting. The formatting of chart data comprises, color used for visualization, shading, brightness, patterns displayed, animation, or sound effects associated with the column. In some embodiments, a column may correspond to live data that is constantly updated from a source and displayed (alternatively the data may be periodically updated at regular time intervals). In some embodiments, for example, FIG. 3(b), positive values in the chart column are shown with a particular formatting whereas negative values are shown using a different formatting (e.g., color). In another embodiment, values shown in the chart column may be divided into various categories and each category may be displayed using a particular type of formatting.

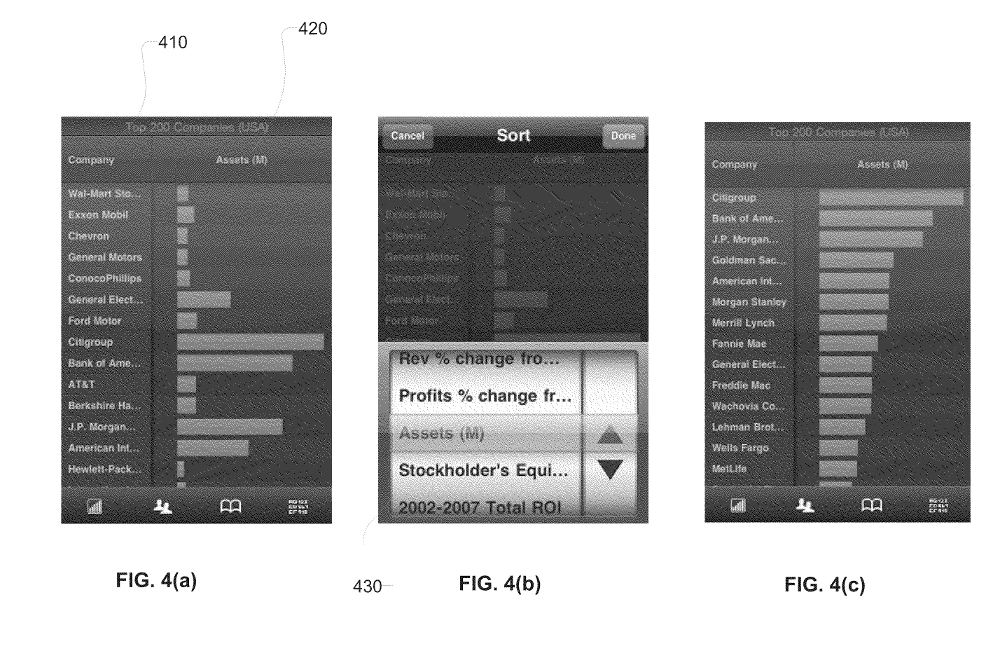

FIG. 4 illustrates how a user can sort table data by selecting a chart column displayed in the table, in accordance with an embodiment of the invention. As shown in FIG. 4(a), a column 420 is selected by the user for display data using chart format. The column 410 is displayed along with the column 420 to identify rows of the table. As shown in FIG. 4(b) the user can select the chart column 420 to specify sorting of the table data based on sorting of the column 420. A user interface widget 430 is presented to the user allowing the user to select any column of the table, including the chart column to specify the sort order (ascending/descending). If the user selects a chart column, the rows of the table are reordered based on the sorted order of the chart column as shown in FIG. 4(c).

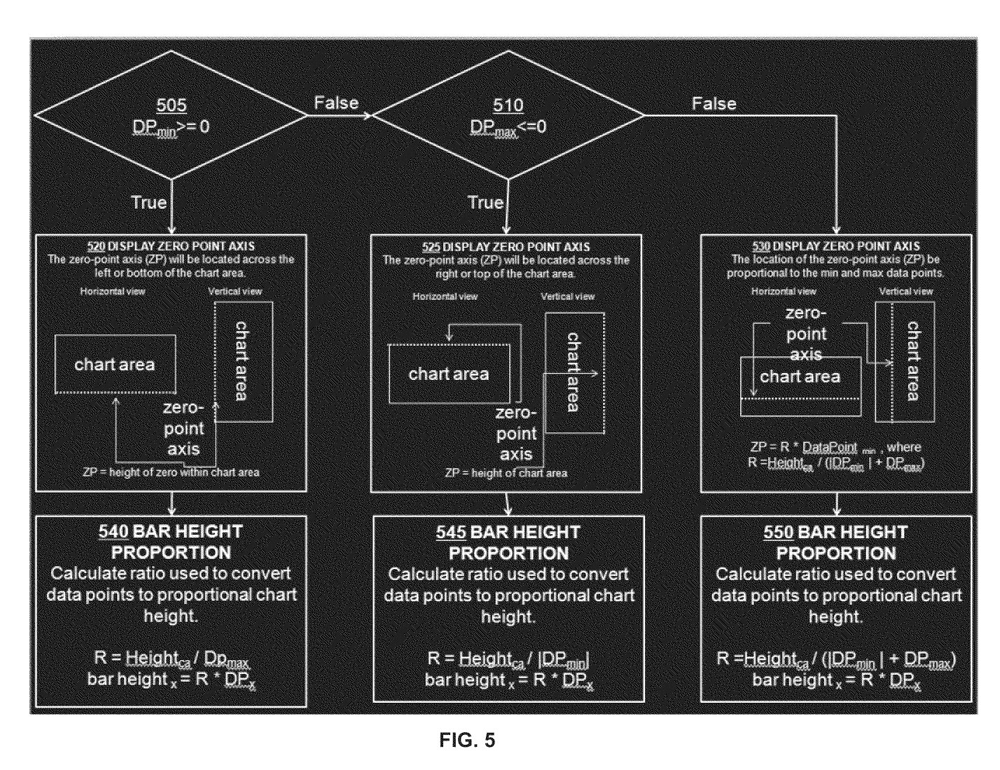

Numeric values of a column can be positive as well as negative. Chart representations typically distinguish between negative values and positive values by displaying them on different sides of an axis. Such an axis is called a zero-point axis since it corresponds to the position where a zero value in the chart is displayed. FIG. 5 shows a flowchart illustrating the process used to determine the zero-point axis for a chart column displayed within a table, in accordance with an embodiment of the invention. Mechanisms of displaying zero-point axis are disclosed in the U.S. patent application Ser. No. 12/363,704 filed on 30 Jan. 2009, which is hereby incorporated by reference in its entirety. If the minimum data point of the chart column DPₘᵢₙ is determined 505 to be greater than zero, all values of the chart are determined to be positive. Accordingly, the zero-point axis is displayed 520 at the lower boundary of the chart area if the chart is displayed horizontally otherwise to the left boundary of the chart area if the chart is displayed vertically. The height barheightₓ of any bar is determined 540 by scaling the value of the cell appropriately based on the maximum height of the bars.

$${barheight}_{x} = \frac{{Height}_{ca}}{{DP}_{max}} * {DP}_{x} \qquad ( 1 )$$

In equation (3), the Height_{ca} is the height of the chart area that corresponds to the maximum length of the bars, DPₘₐₓ is the value of the cell corresponding to the bar with maximum height, and DPₓ is the value of the cell corresponding to the bar for which the height barheightₓ is being calculated.

If all the values of the chart column are below zero, i.e., DPₘₐₓ<=0, all the values are negative. Accordingly, the zero-point axis is displayed 525 at the upper boundary of the chart area if the chart is displayed horizontally otherwise to the right boundary of the chart area if the chart is displayed vertically. The height of each bar is determined 545 by the following equation (2).

$${barheight}_{x} = \frac{{Height}_{ca}}{\vert {DP}_{min} \vert} * {DP}_{x} \qquad ( 2 )$$

The tallest bar corresponds to the minimum cell value DPₘᵢₙ. Since the DPₘᵢₙ value is negative, equation (3) uses the absolute function, represented by |DPₘᵢₙ| to compute a positive barheightₓ value.

If the chart column has values that are both positive and negative, some bars are displayed on one side of the zero-point axis and some on the opposite side of the zero-point axis. In this case, the zero-point axis is displayed between the lower edge and the upper edge in a horizontal view (or between the left and the right edge in a vertical view) such that the bars can be displayed on either side of the zero-point axis. In one embodiment, the distance Xheight of the zero-point axis from the lower edge in a horizontal (or left edge in a vertical view) is calculated based on equation (3):

$$Xheight = \frac{\vert {DP}_{min} \vert * {Height}_{ca}}{( \vert {DP}_{min} \vert + {DP}_{max} )} \qquad ( 3 )$$

In a horizontal view, bars corresponding to negative values are displayed below the zero-point axis and the bars corresponding to the positive values are displayed above the zero-point axis. Alternatively, in a vertical view, the bar corresponding to negative values are displayed to the left of the zero-point axis and the bars corresponding to positive values are displayed to the right zero-point axis. The height of a bar barheightₓ in this case is calculated using the equation (4).

$${Bheight}_{x} = \frac{{DP}_{x} * {Height}_{ca}}{( \vert {DP}_{min} \vert + {DP}_{max} )} \qquad ( 4 )$$

In an embodiment, if the range of values to be displayed in small but the individual values are large, for example, all values ranging between 1000 and 1100, a zero-point axis may be drawn at a value in the above range even though it does not correspond to the zero value. For example, a zero-point axis may correspond to the value 1050 and the values displayed on either side of the zero-point axis. Alternatively, either the value 1000 or the 1100 may be selected as the zero-point axis and the values displayed on the appropriate side.

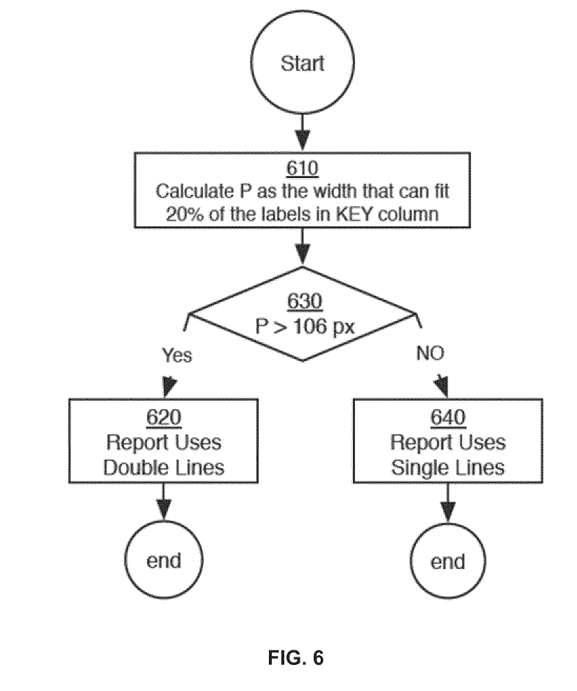

FIG. 6 shows a flowchart illustrating the process used to determine whether a report uses single lines or double lines to display data in a cell, in accordance with an embodiment of the invention. The DB controller can determine a column of the table as a key column. Typically a key column is the column that can uniquely identify each row of the table. In some embodiments, any column of the table can be considered a key column as specified by a user or determined automatically by the system. In some embodiments, two or more columns combined may be considered a compound key column. Typically the key column is displayed in every report. The criteria for determining whether to display labels as single or multiple lines can be applied to other text columns that do not correspond to the key column(s).

The input/output driver module 120 determines 610 the width necessary to accommodate a fixed percentage (say, S %, e.g., S=20) of the labels of the column (assume the width value is called P). The value P can be described as the maximum width of the smallest S % labels of the column. If the value P is determined 630 to exceed a predetermined threshold width value (T), the report is displayed 620 using double lines otherwise the report is displayed 640 using single lines. In some embodiments the predetermined threshold value T is a fixed number of pixels based on the size of the display screen or a fixed fraction of the screen width (for example, ⅓ of the screen width). For example, for a mobile phone device, the predetermined threshold value T can be 106 pixels (which is approximately ⅓ of a typical IPHONE screen). In other embodiments, the predetermined threshold value may depend on the number of columns being displayed on the screen for the report. Accordingly if the single line representation of the column is likely to truncate a percentage of the labels above a threshold value, the input/output driver module 120 displays the table using multiple lines, e.g., double lines.

A column of a report can be displayed in a collapsed form or an expanded form. The width of the column in the collapsed or expanded form is determined based on factors including the size of the screen used to display, the sizes of the labels to be displayed in the cells of the column, and the sizes of other columns that may be displayed. The expanded column width is not necessarily the width of the complete screen or the width of the window displaying the table but an estimated value that allows other columns as well as the chart column to be displayed in an aesthetically pleasing manner.

The user can specify input that causes a column that is collapsed to be displayed as an expanded column and to cause an expanded column to be displayed in collapsed form. In an embodiment, the same type of input causes collapsed column to be expanded and expanded columns to be collapsed. Example of inputs that allow user to specify change of display format of the column include double tapping on the data portion of the columns or double tapping on the title of the column. In other embodiments, the user input can be double clicking (depending on the device), single clicking, single tapping, or right clicking followed by selection of an action from the list. Each of the user actions can be performed on either the data portion of the column or the title portion of the column. If double tapping on the data portion of the column causes the column to change format between chart and numeric formats, the system may be configured so that double tapping on the title portion of the column causes the column to change format between collapsed and expanded widths.

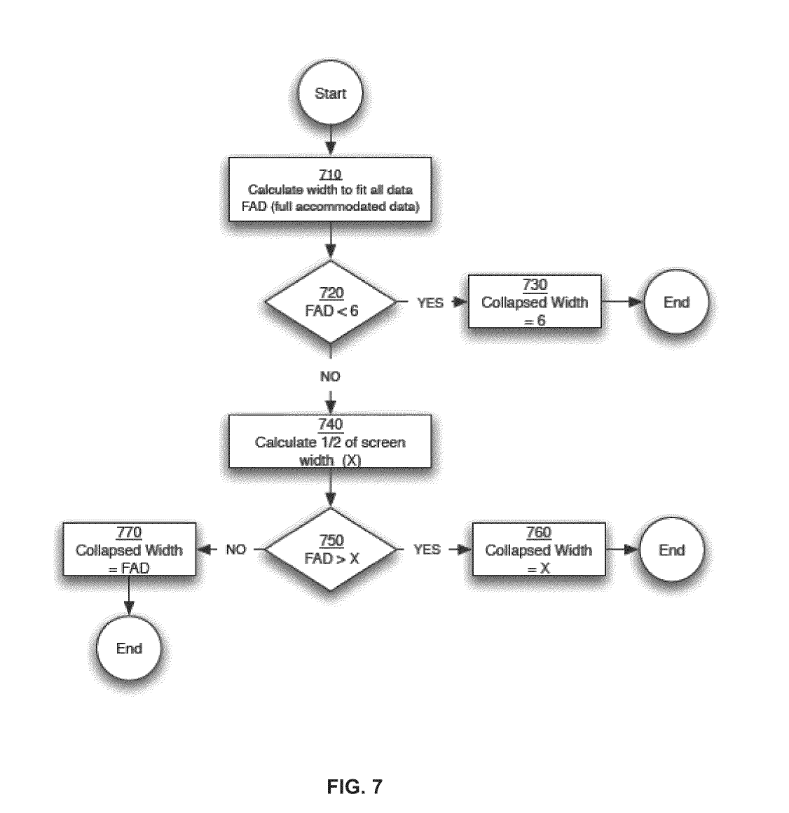

FIG. 7 shows a flowchart illustrating the process used to determine the collapsed width of numeric columns, in accordance with an embodiment of the invention. In an embodiment, the numeric columns are never wrapped to a second line even though the report is using double lines for text columns. The maximum width of all the labels in the cells of the column are determined 710. This width is sufficient to fit data from all the cells of the column (whether or not they are displayed) and is called full accommodated data (FAD). In an alternative embodiment, the FAD is estimated based on the maximum width of all the labels of cells of the column that are currently displayed on the screen (as opposed to all cells that may or may not be displayed). In another alternative embodiment, the FAD is estimated based on the maximum width of the labels of a predetermined percentage of cells of the column or a subset of the cells of the column.

If the labels are determined to be displayed using double lines, the FAD value is based on the maximum width required to display the labels using double lines. Assuming the report is large, the number of cells of the column displayed on the screen may be a subset of all the cells of the column. If the value of FAD is determined 720 to be below a minimum threshold value (say 6 characters), the collapsed width of the column is determined 730 to be the minimum threshold value. The maximum threshold value (X) is determined 740 to be half of the screen size. The value X may change when the display screen changes, e.g., the orientation of the device rotates from portrait to landscape mode. If the value of FAD is determined 750 to be above a maximum threshold value (X), the collapsed width of the column is determined 760 to be the maximum threshold value X. If the value of FAD is determined 770 to be below the maximum threshold value (X), the collapsed width of the column is FAD. The maximum and minimum threshold values can be determined based on criteria including the size of the display screen and the number of columns of the report to be displayed on the screen. The expanded width of numeric columns is the bar chart view of that data.

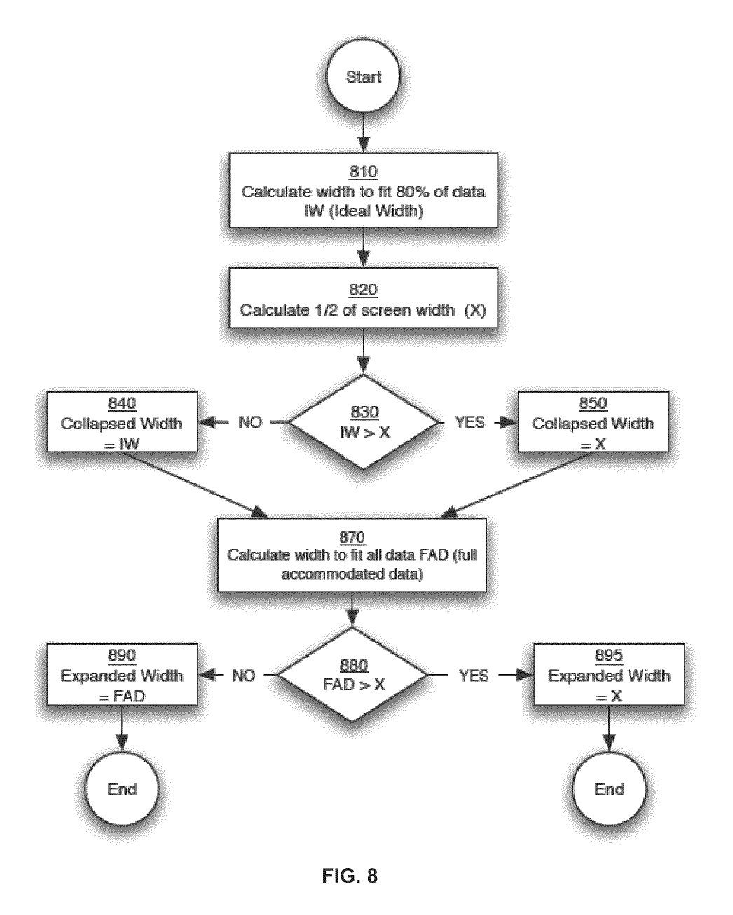

FIG. 8 shows a flowchart illustrating the process used to determine the collapsed and expanded width of a key column. In some embodiments, only the key column may collapse and expand. The input/output driver module 120 determines 810 a value of width required to fit 80% of the data, called the ideal width (IW). A width representing a fraction of the screen size X is calculated 820, for example X can be half the screen size, X. The screen size may change based on the orientation of the device. If the input/output driver module 120 determines 830 the ideal width to be below or equal to the threshold X, then the input/output driver module 120 determines 840 the collapsed width to be same as the ideal width. If the input/output driver module 120 determines 830 the ideal width to be above the threshold X, then the input/output driver module 120 determines 850 the collapsed width to be same as X. The fully accommodated data (FAD) is determined 870. If the FAD is determined 880 to be below the threshold X the expanded width is FAD 890. If the FAD is determined 880 to be above the threshold X the expanded width is X 895.

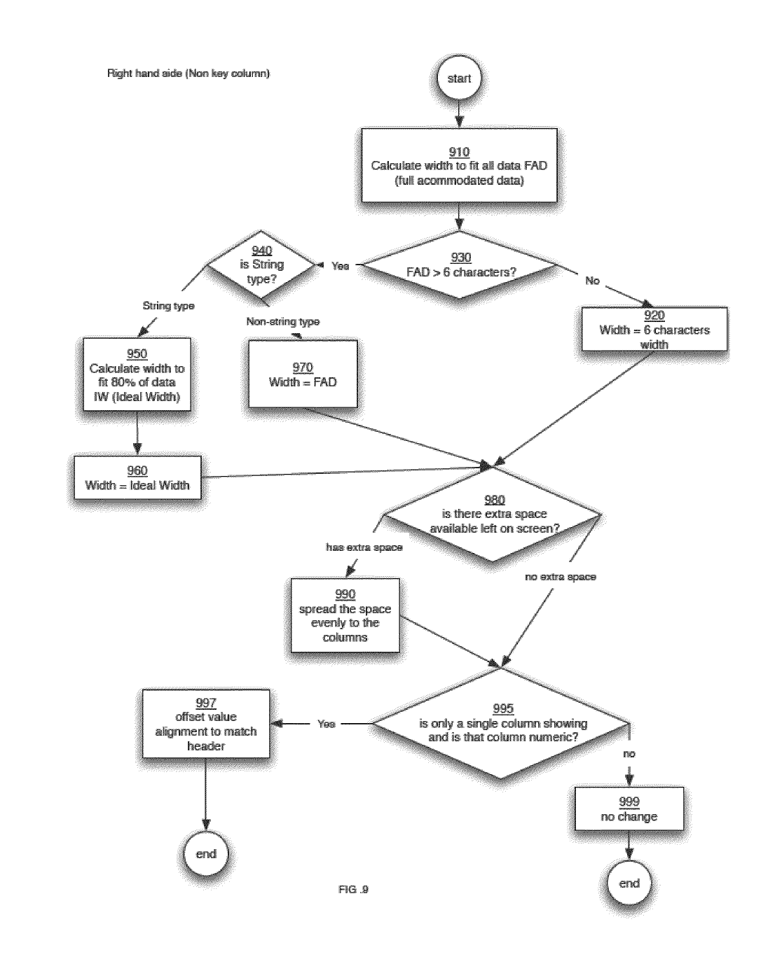

FIG. 9 shows a flowchart illustrating the process used to determine the width of alphanumeric columns, in accordance with an embodiment of the invention. The maximum width of all the labels of the column to be displayed is determined 910. This value is called the full accommodated data (FAD) value for the column. If the FAD value is determined 930 to be less than a fixed threshold value (e.g., 6 characters), the width of the column is determined 920 to be the same as the fixed threshold value. If the FAD value is determined 930 to be greater than or equal to the fixed threshold value, the data type is determined 940. If the data type is string, the width is determined 950, by calculating that 80% (or a predetermined percent L %) of the labels of the column are displayed (ideal width) 960. If the data type is not string, the width is determined 970 to be equal to FAD. Once width is calculated, a determination 980 is made if additional space is available on the display. If there is space available, the column widths are increased 990 evenly. If it is determined 995 that only one column was displayed and if that column is numeric, offset value alignment is performed 997 to match the column header. If the column is determined 999 to be non-numeric, no additional change is required.

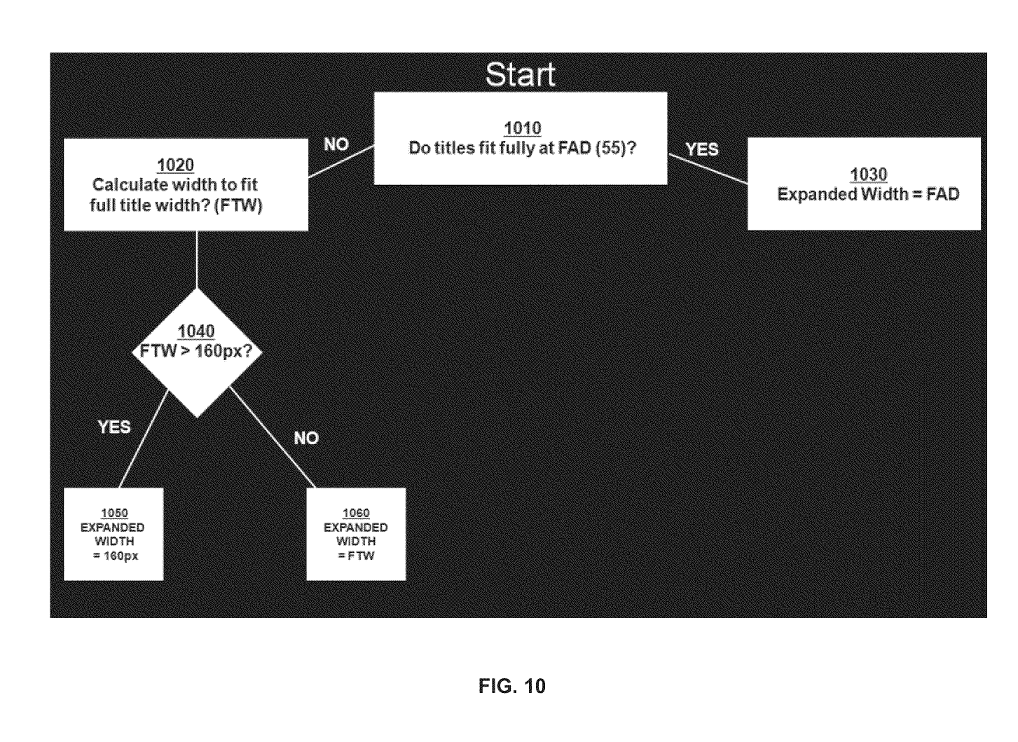

FIG. 10 shows a flowchart illustrating the process used to determine the expanded width of alphanumeric columns, in accordance with an embodiment of the invention. The FAD value is determined as described in FIG. 9. In an embodiment, the process illustrated in FIG. 10 is performed by the input/output driver module 120. The input/output driver module 120 determines 1010 whether the column title label width is less than the FAD value. If the column title is determined 1010 to fit within the FAD value, the input/output driver module 120 determines 1030 the expanded width of the column to be the FAD value. If the input/output driver module 120 determines the column title to exceed the FAD value (i.e., not fit within the FAD value), the input/output driver module 120 determines 1020 the full title width (FTW) value of the title label. If the input/output driver module 120 determines 1040 the FTW value to be above a predetermined threshold value (e.g., 160 pixels for a mobile phone device), the input/output driver module 120 determines 1050 the expanded width is determined 1050 to be the same as the predetermined threshold value, otherwise the expanded width to be the same as the FTW value. Accordingly, if the title is small, the input/output driver module 120 determines 1030 the expanded width to be same as the FAD value (i.e., the expanded width is determined based on the label values in the column), whereas if the title width is large, the input/output driver module 120 determines the expanded width to the minimum of the full title width or the predetermined threshold value.

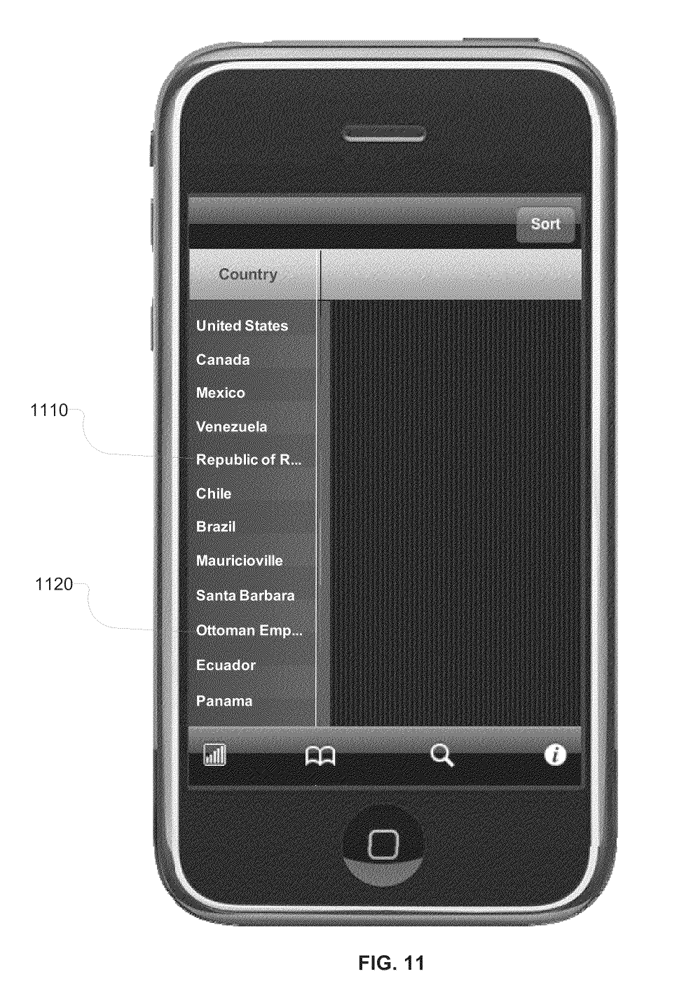

FIG. 11 illustrates a device displaying a table with small column labels displayed as single lines, in accordance with an embodiment of the invention. Some of the labels, e.g., 1110 and 1120 are large and are displayed in a truncated manner. The rest of the labels are small and are not truncated. As shown in FIG. 6, unless the percentage of labels that do not fit the column is greater than a predetermined threshold value, the labels are displayed as single lines.

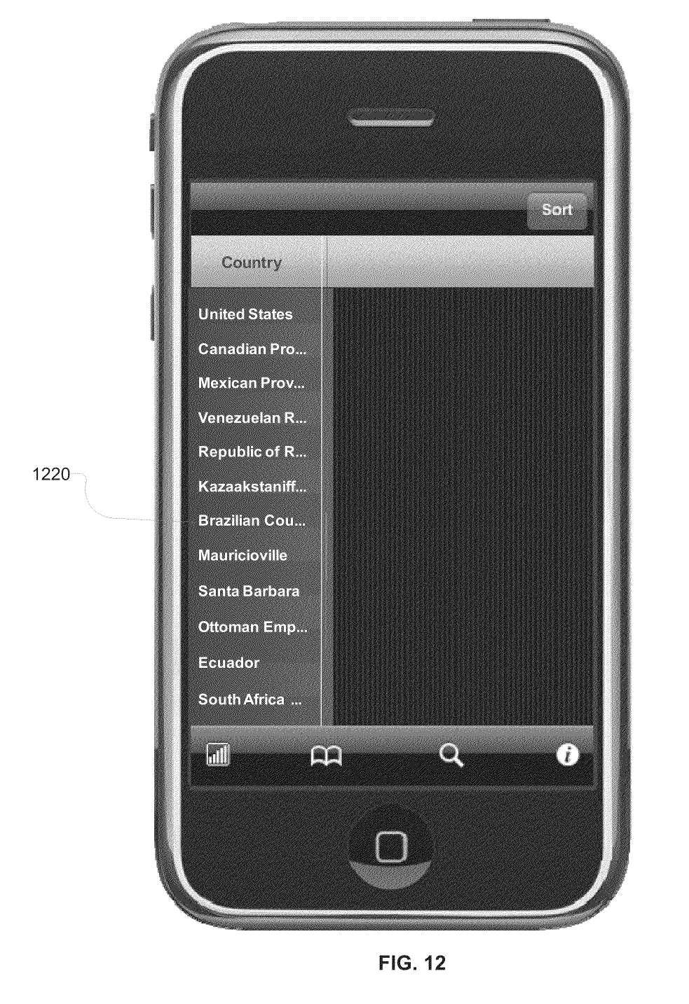

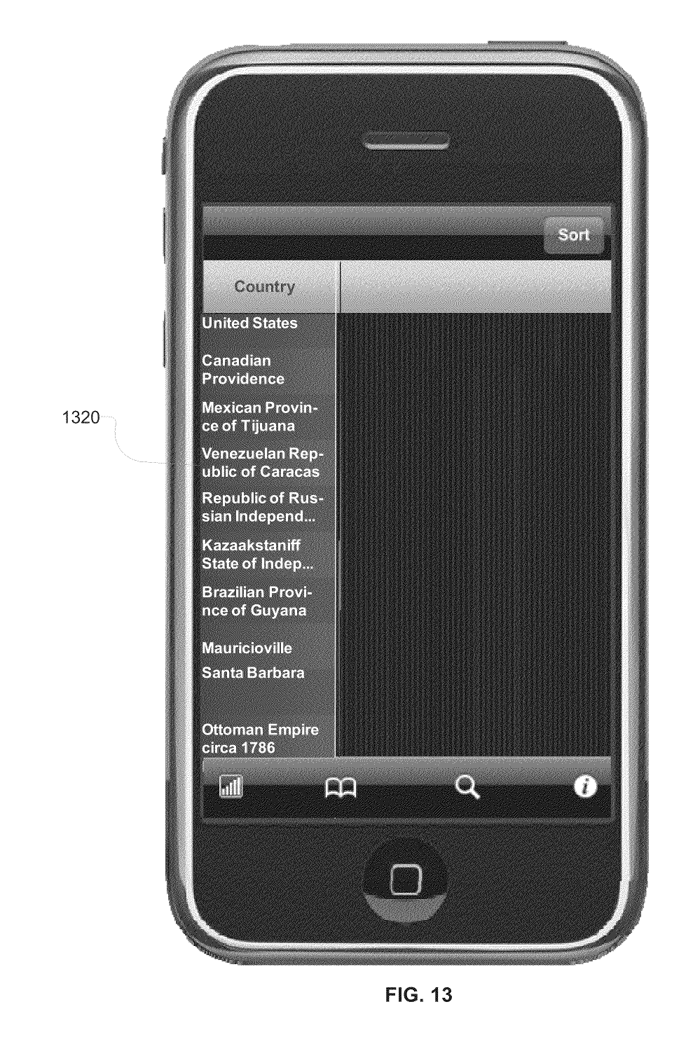

FIG. 12 illustrates a device displaying a table with large column labels displayed as single lines, in accordance with an embodiment of the invention. As shown in FIG. 12, even though the percentage of labels that do not fit the column width is large, the labels (e.g., label 1220) are displayed as single lines and are truncated. This results in a display that causes loss of information that a user may be interested in viewing. Accordingly the labels of FIG. 12 should be displayed using double lines as shown in FIG. 13.

FIG. 13 illustrates a device displaying a table with large column labels displayed as double lines, in accordance with an embodiment of the invention. According to FIG. 6, if the number of labels that do not fit the column width exceeds a predetermined percentage value, the labels are displayed as double lines (e.g., label 1320) as shown in FIG. 13. Since the labels are shown as double lines, the total number of rows displayed on the screen is reduced and a smaller portion of the report can be displayed on the screen.

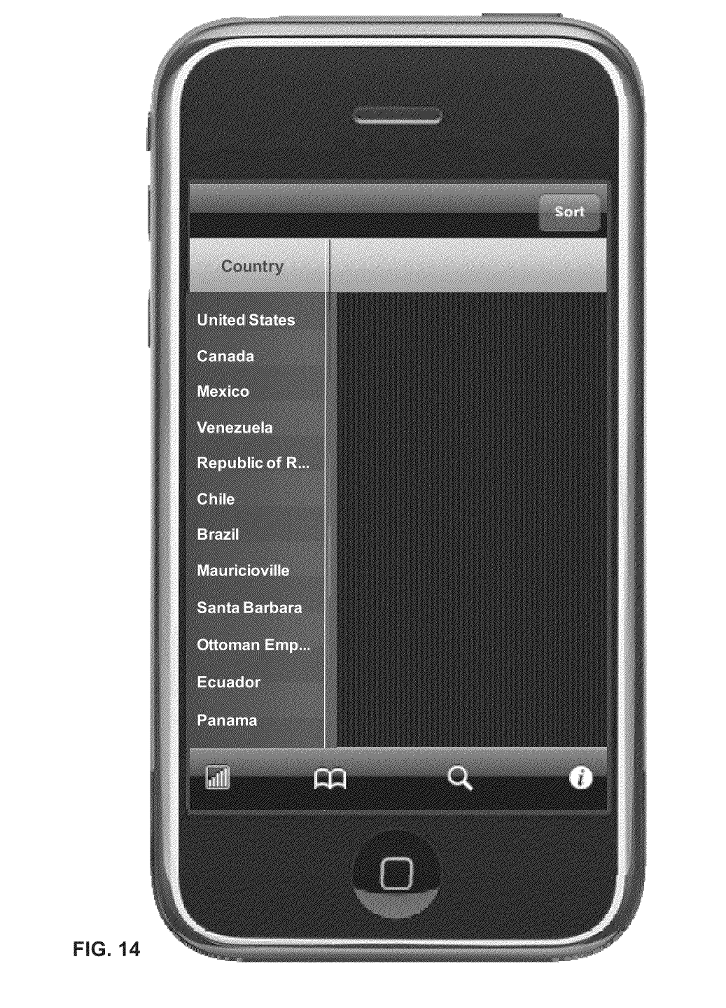

FIG. 14 shows a device illustrating a column displayed using the collapsed width of the column, in accordance with an embodiment of the invention. A user can provide input to indicate that the column should be displayed using expanded width, for example, by double tapping on the column or on the title of the column. In the example displayed in FIG. 14, the FAD value exceeds the predetermined threshold value as shown in 7.

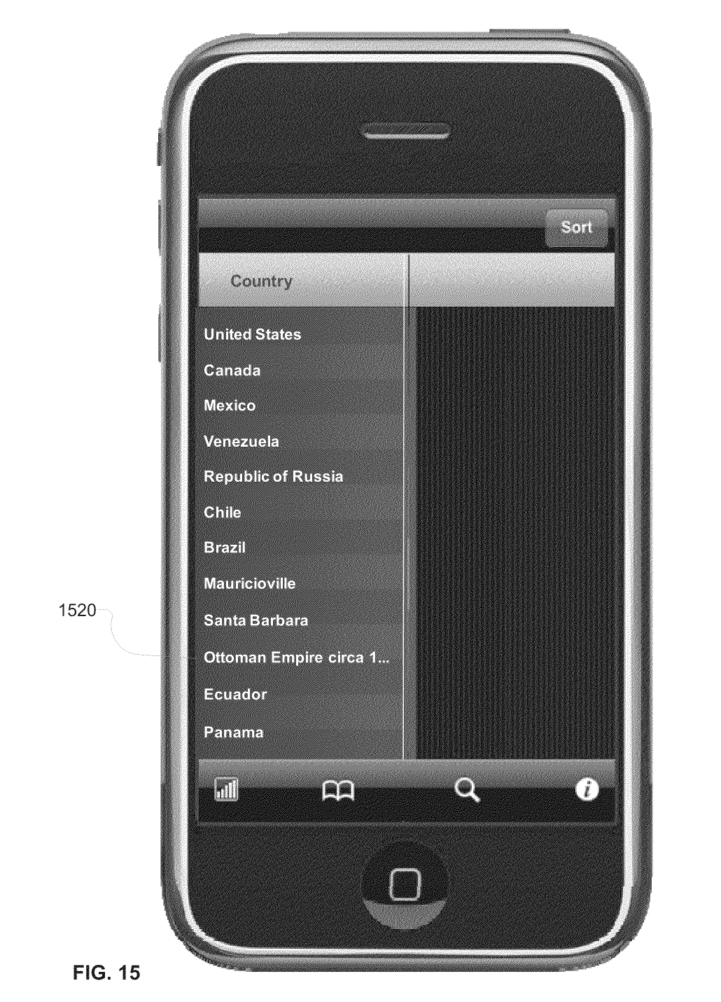

FIG. 15 shows a device illustrating a column displayed using the expanded width of the column that reaches the maximum possible expanded width, in accordance with an embodiment of the invention. The report shown in FIG. 15 may have been obtained by the user by double tapping on the screen displaying the image in FIG. 14. Even though the label 1520 is truncated, the expanded width does not exceed a maximum possible threshold value (e.g., 160 pixels for typical mobile devices) as illustrated in FIG. 8. The report illustrated in FIG. 15 is a single line report.

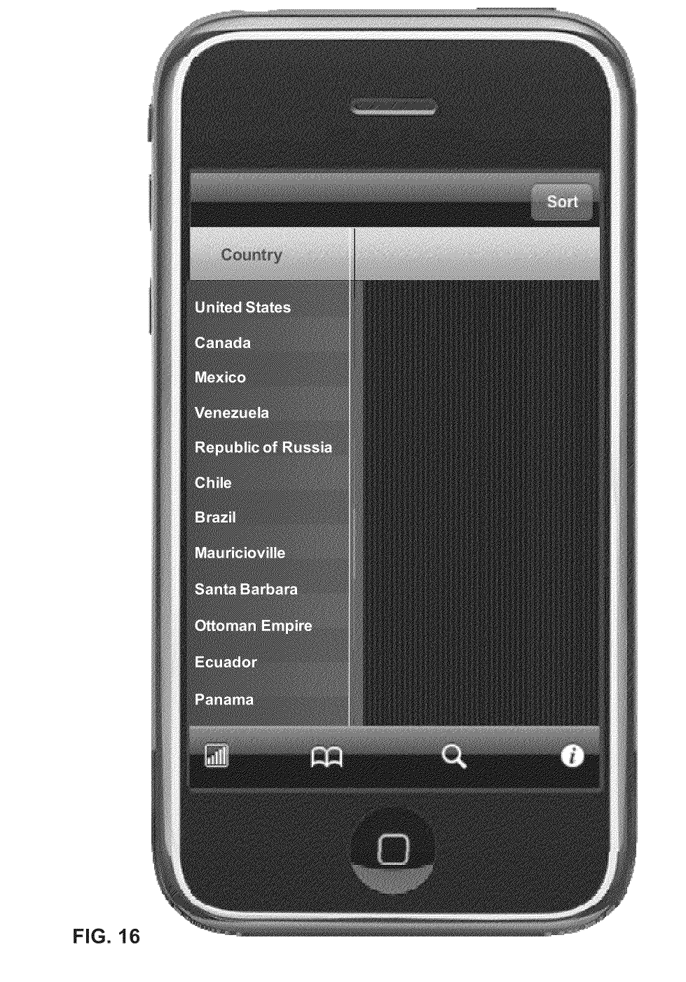

FIG. 16 shows a device illustrating a column displayed using the expanded width that is less than the maximum possible expanded width, in accordance with an embodiment of the invention. In this case, the FAD of the column as determined by taking the maximum width of all the labels of the column is greater than the collapsed width (e.g., 106 pixels) but less than the highest possible expanded width (e.g., 160 pixels). None of the labels displayed in FIG. 16 are truncated.

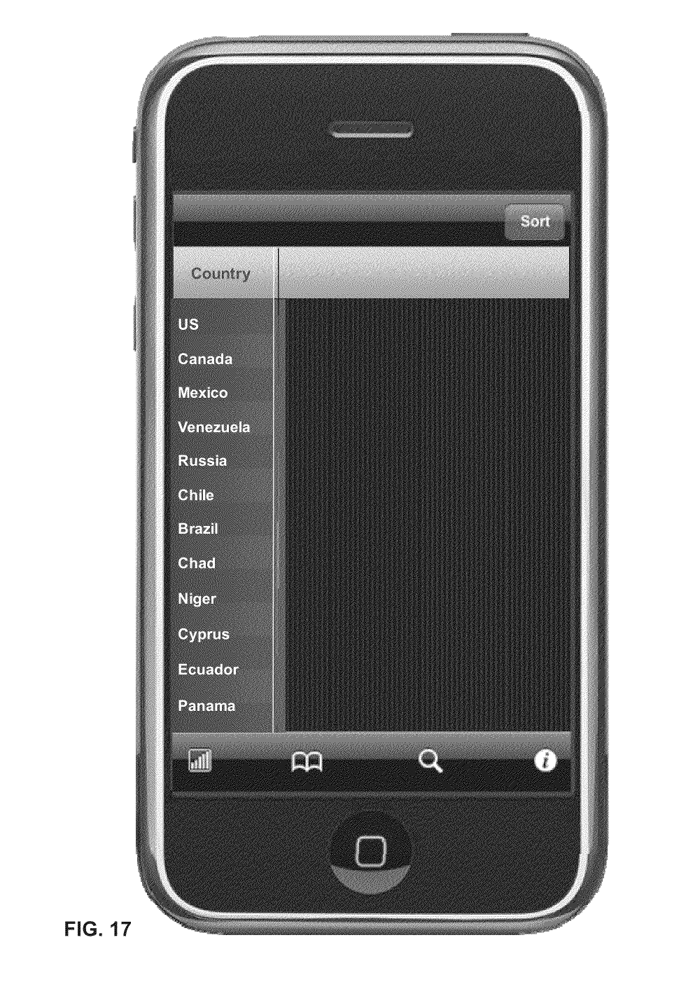

FIG. 17 shows a device illustrating a column that is displayed using a collapsed width that is same as its expanded width, in accordance with an embodiment of the invention. This happens when all the labels of the column are below the collapsed width (e.g., 106 pixels). In this situation, the column width is reduced to fit all the labels unless the required width is below the minimum threshold (e.g., 10 pixels) in which case the width is set to the minimum threshold value. Accordingly the collapsed width of the column is same as the expanded width of the column. Providing user input to change from collapsed view to expanded view or vice versa has no effect in this situation.

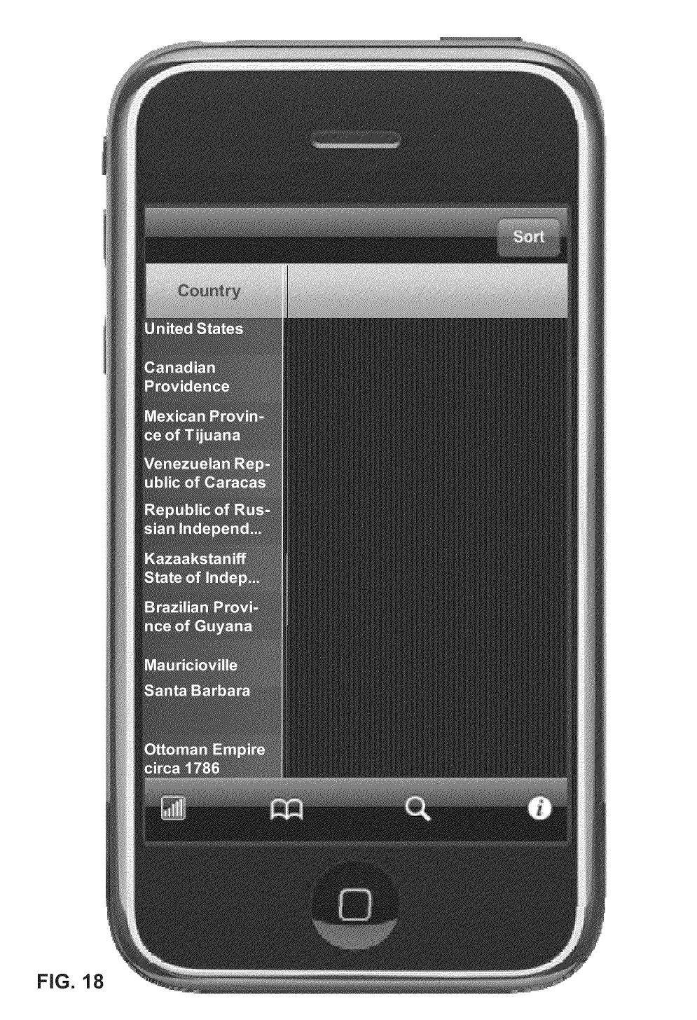

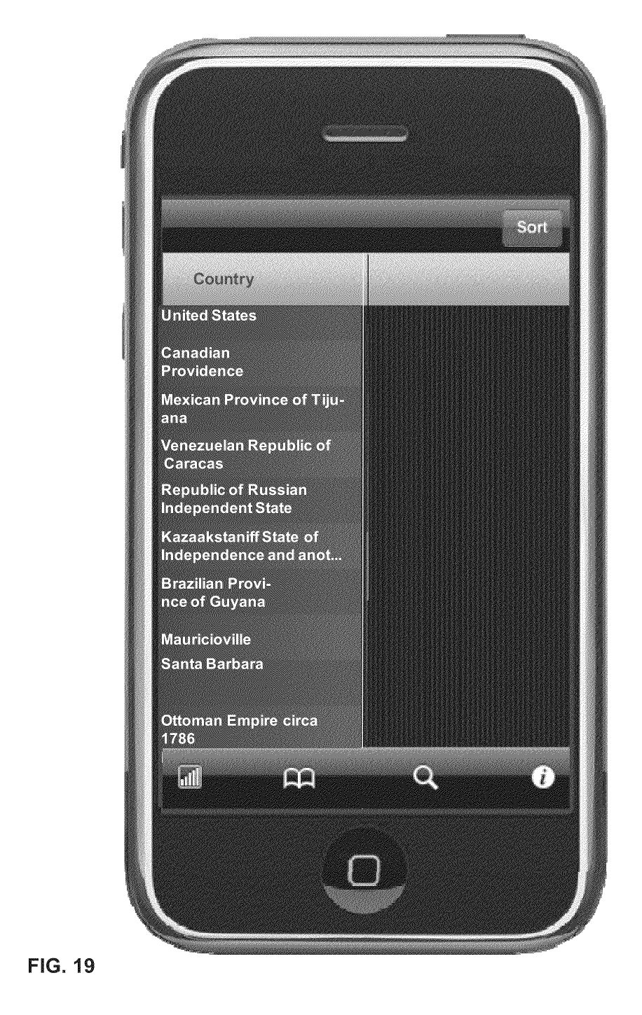

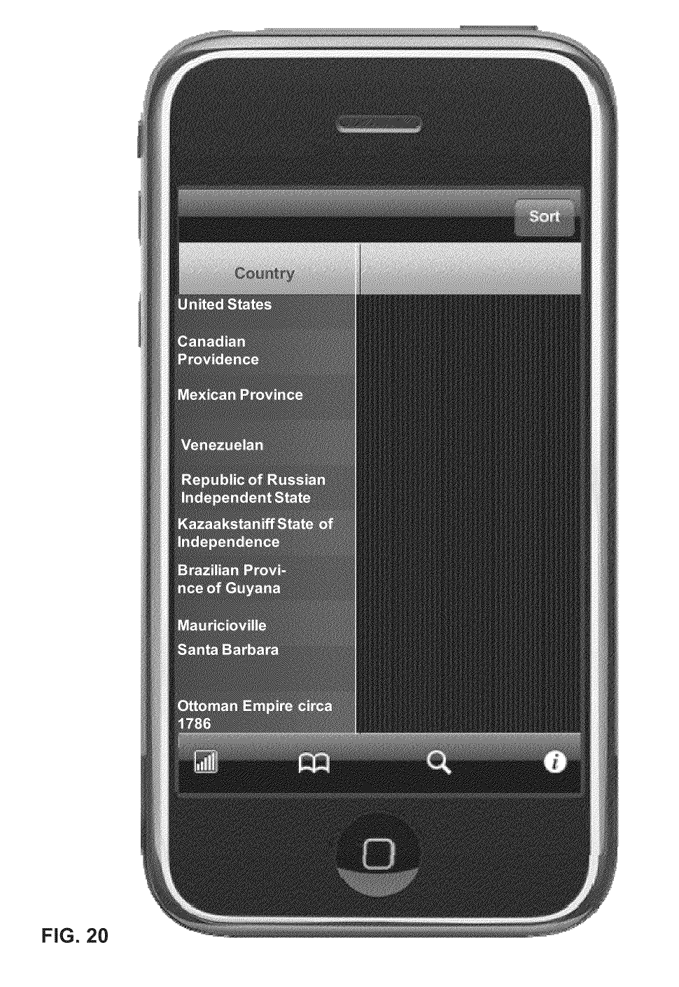

FIG. 18 shows a device illustrating a column displayed using double lines with collapsed width, in accordance with an embodiment of the invention. In this situation, the FAD value of the column is determined based on the maximum width of the labels if they are displayed using double lines. FIG. 19 shows the device illustrating a column displayed using double lines with expanded width. The expanded view shown in FIG. 20 can be obtained, for example, by double tapping on the column or the title as shown in FIG. 19. FIG. 20 shows the device illustrating a column displayed using double lines with expanded width that does not reach the maximum possible expanded width value. In this case the width of the labels as displayed using double lines is greater than the collapsed width (e.g., 106 pixels) but below the maximum expanded width (e.g., 160 pixels).

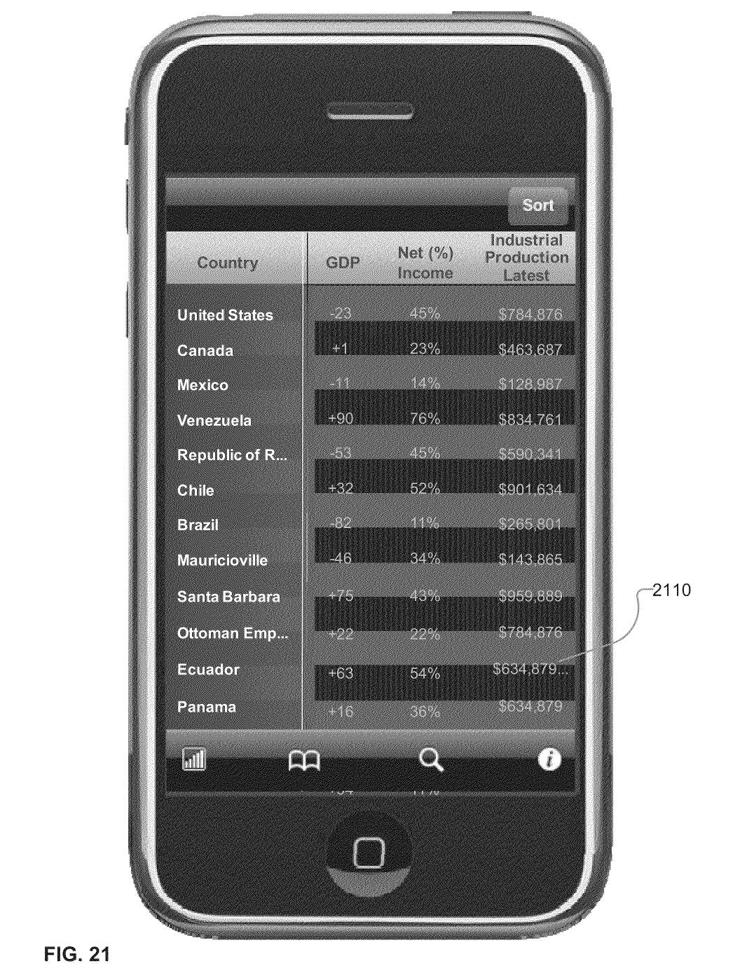

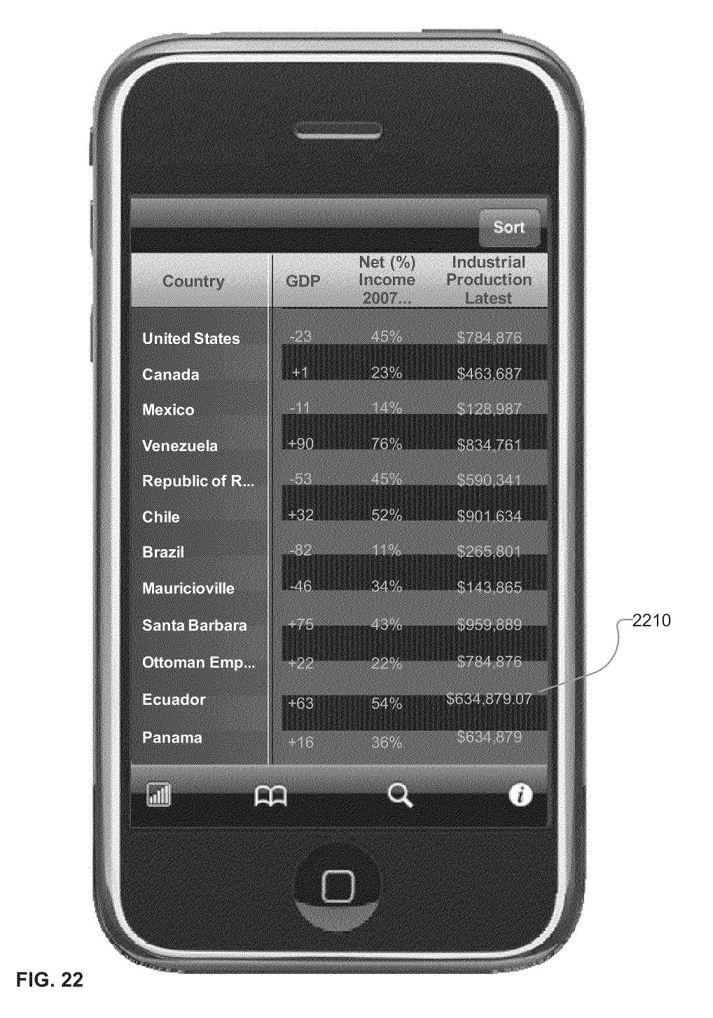

FIG. 21 illustrates a numeric column containing data that exceeds the column width, thereby requiring truncation of the date, in accordance with an embodiment of the invention. In some embodiments, certain labels, e.g., label 2110 may exceed the column width resulting in the label being displayed as a truncated value. However, as shown in FIG. 22, an attempt is made to expand the column width in order to display the numeric value without truncation.

FIG. 22 illustrates the numeric column data of FIG. 21 displayed without truncation, in accordance with an embodiment of the invention. In some embodiments, only a single column may be expanded to display all values of the column without truncation. In other embodiments at most a fixed number of columns can be expanded to display all values without truncation. Presentation of the values without truncation results in a better user experience compared to display of truncated values.

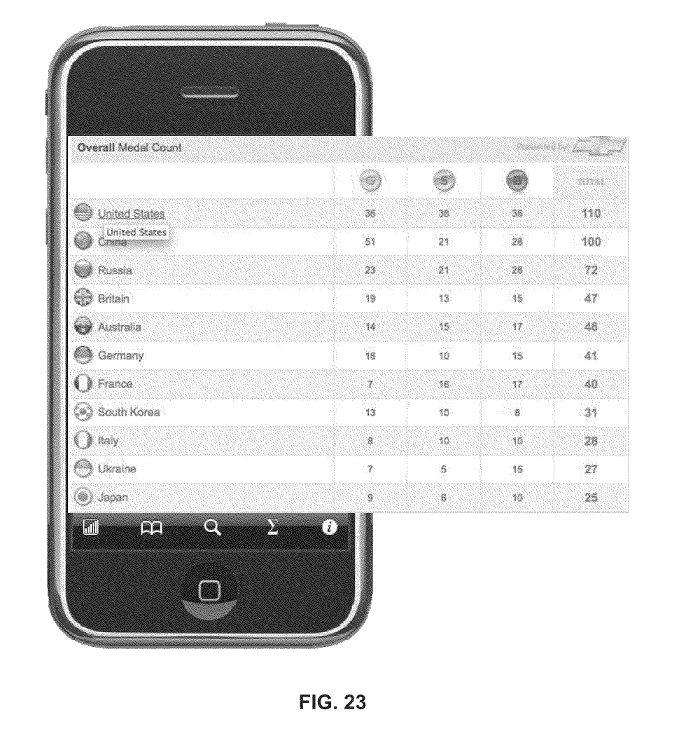

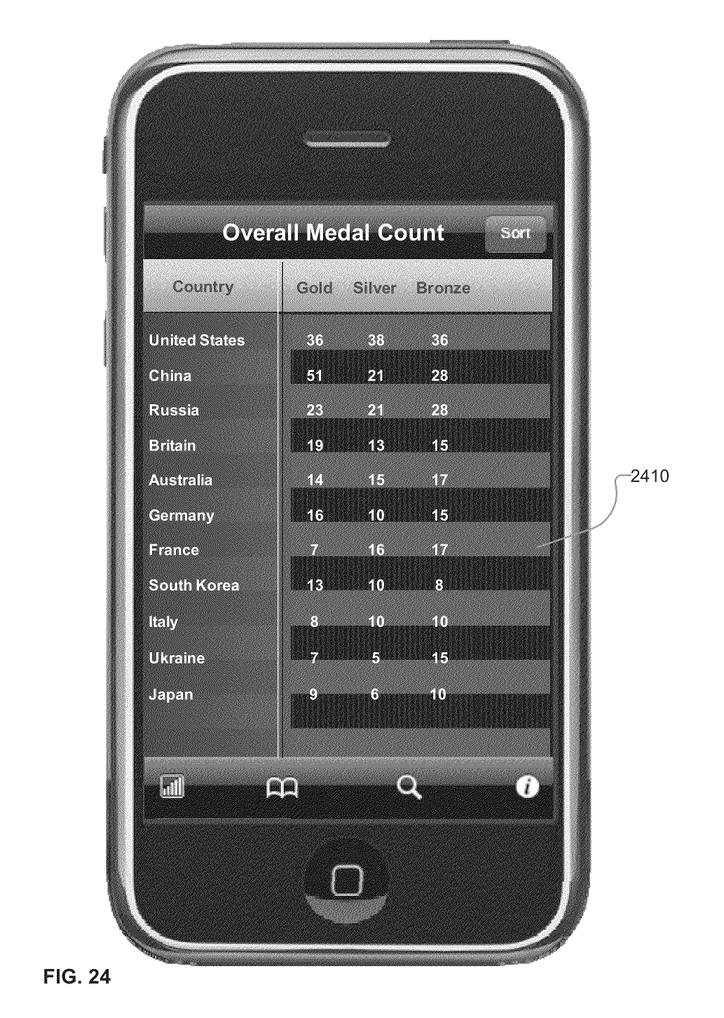

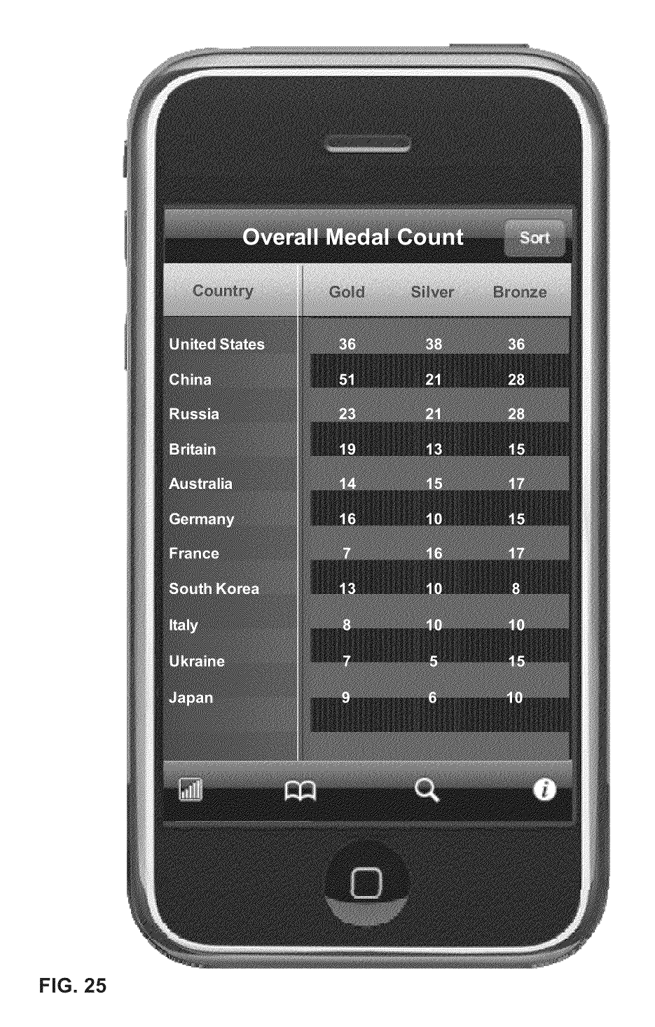

FIG. 23 shows a sample data set to be displayed as a report using a device with limited display area. The data set to be displayed comprises values that do not require very large width to display. FIG. 24 shows a device illustrating display of the report shown in FIG. 23 in a manner that shows empty space in the report. Since the columns can be displayed using the widths based on the labels of the column that are very small, the total size of all columns together is small and results in empty space 2410 in the report. The empty space shown in the display of the report of FIG. 24 can be evenly distributed across all the columns resulting in the display as shown in FIG. 25. The display shown in FIG. 25 is more aesthetically pleasing than the display shown in FIG. 24.

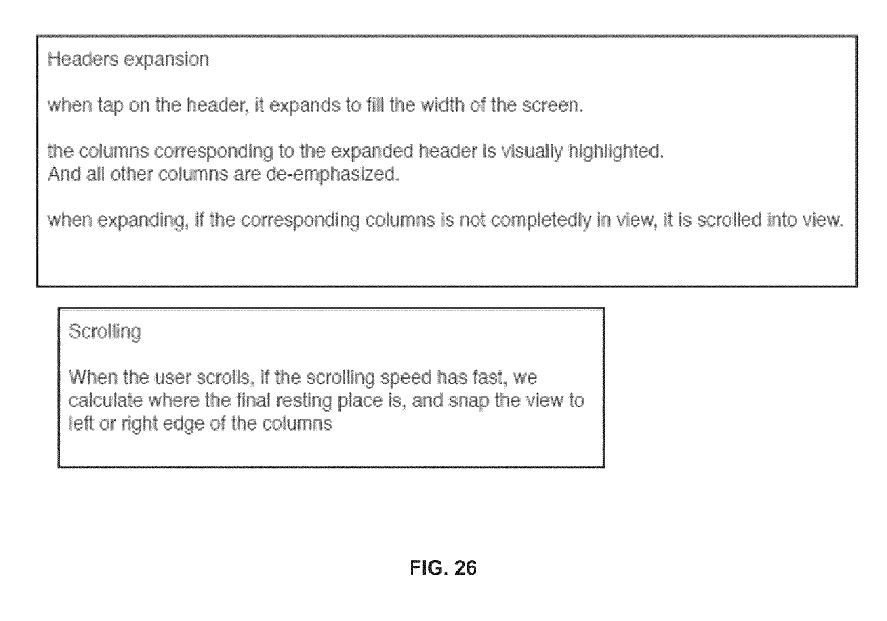

FIG. 26 describes alternative embodiments related to header expansion and scrolling of the table. In an embodiment, if the user tabs/double taps on the header, the header can expand to fill the widths of the screen. In another embodiment, the header may expand to fill a fraction of the screen. The columns corresponding to the expanded header may be visually highlighted and all other columns may be deemphasized. If column that is not completely in view expanded, the column is automatically scrolled into view. If a user scrolls the table and the scrolling speed is fast, an estimate is made as to where the scrolling is expected to stop. The view of the table is snapped to the left or right edges of the columns.

It is to be understood that the Figures and descriptions of the present invention have been simplified to illustrate elements that are relevant for a clear understanding of the present invention, while eliminating, for the purpose of clarity, many other elements found in a typical system that allows users to view report data. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for displaying table data in a limited display area, the method comprising:
displaying a table comprising a plurality of columns, each column comprising cells presenting values, at least one column displayed using text format;
receiving input identifying a target column displayed using text format, the input requesting presentation of the target column in chart format;
selecting a key column for presentation in text format such that values of cells of the key column are presented as labels in text format; and
changing presentation of the table such that the target column is displayed along with the key column, the target column displayed in a chart format comprising shapes, each shape associated with a cell of the target column, the presentation of the shape determined based on the value associated with the cell.

2. The computer-implemented method of claim 1, wherein each cell of the key column is associated with a value that uniquely identifies the row of the table corresponding to the cell.

3. The computer-implemented method of claim 1, wherein the chart format is a bar graph and each shape is a rectangle.

4. The computer-implemented method of claim 1, further comprising:
presenting one or more additional columns, the number of additional columns determined based on a size of a display screen used for presenting the table.

5. The computer-implemented method of claim 1, further comprising:
presenting an auxiliary column corresponding to the target column, the auxiliary column presenting values of the chart column in text format.

6. The computer-implemented method of claim 1, wherein the input requesting presentation of the target column comprises a single-action user input.

7. The computer-implemented method of claim 6, wherein the single action input is one of a single tap, a single click, a double tap, or a double click operation.

8. The computer-implemented method of claim 6, wherein single action is performed on a title portion of the target column.

9. The computer-implemented method of claim 6, wherein single action is performed on a data portion of the target column.

10. The computer-implemented method of claim 1, wherein the input is a first input, the method further comprising:
receiving a second input identifying the target column displayed in chart format; and
changing presentation of the target column to text format.

11. The computer-implemented method of claim 1, wherein presenting a column in text format comprises:
selecting a subset of smallest labels such that a label belonging to the subset is smaller that all labels of the column outside the subset; and
responsive to an aggregate value of length of the labels belonging to the subset exceeding a threshold value, displaying cells of the column such that each label is presented using a plurality of lines.

12. The computer-implemented method of claim 11, wherein presenting a column in text format further comprises:
responsive determining that the aggregate value of length of the labels belonging to the subset is below a threshold value, displaying labels of each cell of the column using single line;

13. The computer-implemented method of claim 11, wherein the threshold value is based on a predetermined fraction of the display screen width.

14. The computer-implemented method of claim 1, wherein the width of a column presented in text format is determined based on a maximum width of labels of the column presented on a display screen.

15. A system for displaying table data in a limited display area, the system comprising:
a computer processor; and
a computer-readable storage medium storing computer program modules configured to execute on the computer processor, the computer program modules comprising:
an input/output driver module configured to:
display a table comprising a plurality of columns, each column comprising cells associated with values;
receive input identifying a target column displayed using text format, the input requesting presentation of the target column in chart format;
select a key column for presentation in text format such that values of cells of the key column are presented as labels in text format; and
change presentation of the table such that the target column is displayed in a chart format comprising shapes, each shape associated with a cell of the target column, the presentation of the shape determined based on the value associated with the cell.

16. The system of claim 15, wherein the input/output driver module is further configured to:
present one or more additional columns, the number of additional columns determined based on a size of a display screen used for presenting the table.

17. The system of claim 15, wherein the input/output driver module is further configured to:
present an auxiliary column corresponding to the target column, the auxiliary column presenting values of the chart column in text format.

18. A computer program product having a computer-readable storage medium storing computer-executable code for displaying table data in a limited display area, the code comprising:
an input/output driver module configured to:
display a table comprising a plurality of columns, each column comprising cells associated with values;
receive input identifying a target column displayed using text format, the input requesting presentation of the target column in chart format;
select a key column for presentation in text format such that values of cells of the key column are presented as labels in text format; and
change presentation of the table such that the target column is displayed in a chart format comprising shapes, each shape associated with a cell of the target column, the presentation of the shape determined based on the value associated with the cell.

19. The computer program product of claim 18, wherein the input/output driver module is further configured to:
present one or more additional columns, the number of additional columns determined based on a size of a display screen used for presenting the table.

20. The computer program product of claim 18 wherein the input/output driver module is further configured to:
present an auxiliary column corresponding to the target column, the auxiliary column presenting values of the chart column in text format.
